(19) United States
(12) Patent Application Publication
(10) Pub. No.: US 2012/0055778 A1
(43) Pub. Date: Mar. 8, 2012

(54) System and Method for Purifying Water

(76) Inventor: Kristopher Schehr, Colorado Springs, CO (US)

(21) Appl. No.: 12/874,373

(22) Filed: Sep. 2, 2010

(51) Int. Cl. C02F 1/04; B01D 3/00

(52) U.S. Cl. 203/10; 202/185.1

(57) ABSTRACT

A system and method of water purification includes a dirty water tank (1), and a power source (2), to create clean water (8). A fuel cell (3) is utilized to convert clean water to oxygen and hydrogen which is mixed (4) to create Oxyhydrogen. The Oxyhydrogen is burned in torches (6) producing heat and pure water. The pure water is collected, and the heat is used in a steam still (7) to boil water to steam, the steam is condensed and collected as clean water (8). This clean water is provided for consumption as well as supplied to the fuel cell (3) for further production.

### BACKGROUND OF THE INVENTION

This invention generally relates to water purification, specifically to using an oxygen and hydrogen mix referred to as Oxyhydrogen in conjunction with a steam still as an improved means of purifying water.

Water purification has been accomplished through boiling of water into steam, cooling of that steam, and collection of the resulting purified water in a significant number of ways. The primary variation between applications has been in the means of heating the water to the point of steam.

Solar stills have been utilized to purify water through evaporation using the sun as a direct heat source such as in U.S. Pat. No. 5,053,110 however these methods were inefficient due to the minimal energy captured from the sun to apply to steam conversion as well as operating stoppage related to cloud cover and night time.

Other water purifier solutions used heat sources such as electric coil elements to produce heat for steam however these solutions required relatively large amounts of electricity such as detailed in U.S. Pat. Nos. 3,957,589 and 4,045,293 making them difficult to implement efficiently or portably.

Burning gasses such as methane and propane have been utilized in conjunction with steam stills as however this method requires combustible gases from external sources leads to difficulties in transport and supply as well as higher relative production costs.

The indirect heat off of a fuel cell stack has been used as a heat source for a steam generator and water purification unit such as claimed in patent application 2007/0072027 and U.S. Pat. No. 4,120,787 however this application required the input of hydrogen or hydrocarbon fuels into a high temperature fuel cell such as a solid oxide fuel cell necessitating the delivery of combustible gasses to the purifier which can be difficult and costly, especially in remote and portable applications.

Oxyhydrogen as a heat source has been produced using electrolysis as detailed in patent application Ser. No. 11/400,994 and U.S. Pat. No. 5,244,558 however to obtain efficient operation electrolysis required introduction of secondary elements into the source water which tend to be caustic. Oxyhydrogen has also been proposed for power and heat generator such as in application Ser. No. 9/771,341. None of the aforementioned inventions however applied Oxyhydrogen to in water purification.

Oyxhydrogen has also been proposed for purification in waste treatment applications such as in patent application Ser. No. 11/565,240 however this particular method is for the removal of large contaminants and does not utilize a steam still or infer intention towards potable water.

### BRIEF SUMMARY OF INVENTION

In accordance with the invention, this invention provides an improved means of purifying water using Oxyhydrogen as a heat source for a steam still as well as reclaiming water from the combustion process.

Accordingly, several objects and advantages of the Oxyhydrogen water purifier are the efficient purification of water using simple and abundant system inputs of electricity, and dirty water. The efficiency of this purifier allows the system to operate with smaller power sources such as solar power cells. The internal generation of Oxyhydrogen by a fuel cell alleviates the requirement of providing external flammable gas sources to the purifier. The extreme flammability of Oxyhydrogen as well as its post-burn byproduct of water make it extremely efficient in the application of water purification as a heat source for steam stills. The simplicity of design and minimum of moving parts allows for less wear leading to longer device life.

Further objects and advantages will become apparent from a consideration of the ensuing description and drawings.

### BRIEF DESCRIPTION OF THE SEVERAL VIEWS OF THE DRAWINGS

FIG. 1 is a view of the water purification system in accordance with one embodiment of the invention.

FIG. 2 is a view of the functional steps of the system in accordance with one embodiment of the invention.

FIG. 3 is a detailed view of a potential embodiment of the torch in accordance with one embodiment of the invention.

### DETAILED DESCRIPTION OF THE INVENTION

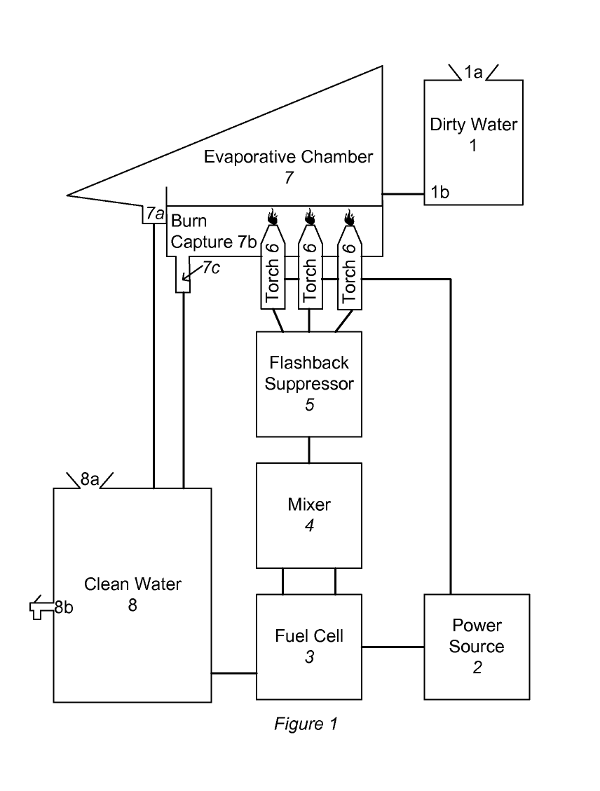

FIG. 1 shows a basic version of my water purifier.

A dirty water tank 1 is used for storage of water to be purified. This dirty water tank can contain water with different impurities including but not limited to salt, pollution, and particulates. The dirty water or input tank 1 has a port 1a included to add water from outside of the invention. The dirty water tank includes means to control water flow to the output port 1b.

A power source 2 is used to provide electricity to the invention. This power source can be but is not limited to solar power cells, wind turbines, batteries, electrical grid connections, or any suitable source of electrical energy. A fuel cell 3 is a device which takes clean water and electricity as an input and outputs oxygen and hydrogen as an output. This fuel cell can be but is not limited to a Polymer Electrolyte Membrane/Proton Exchange Membrane (PEM) Electrolyzer full cell in oxygen and hydrogen production mode.

A mixer 4 is a device which efficiently mixes oxygen and hydrogen to an Oxyhydrogen gas.

A flashback suppressor 5 blocks combustion from flowing from its output port to its input port. This device is used as a safety item in the invention.

A single or plurality of torches 6 are used to ignite and burn the Oxyhydrogen gas powered by the power source 2.

A steam still 7 is used to boil dirty water into steam and condense and collect the steam into clean water in the collection port 7a. In addition the steam still provides means (burn chamber) 7b to capture 7c (opening) water byproduct from burning Oxyhydrogen from the touches 6. In addition the steam still provides a means to output/clean out the materials left behind after steam evaporation. A clean water tank 8 is used to collect the clean water produced by the system as well as provide clean water to the fuel cell. The clean water tank includes a port 8a to initially prime the system with clean water. In addition the clean water tank 8 provides a port 8b to output clean water from the system.

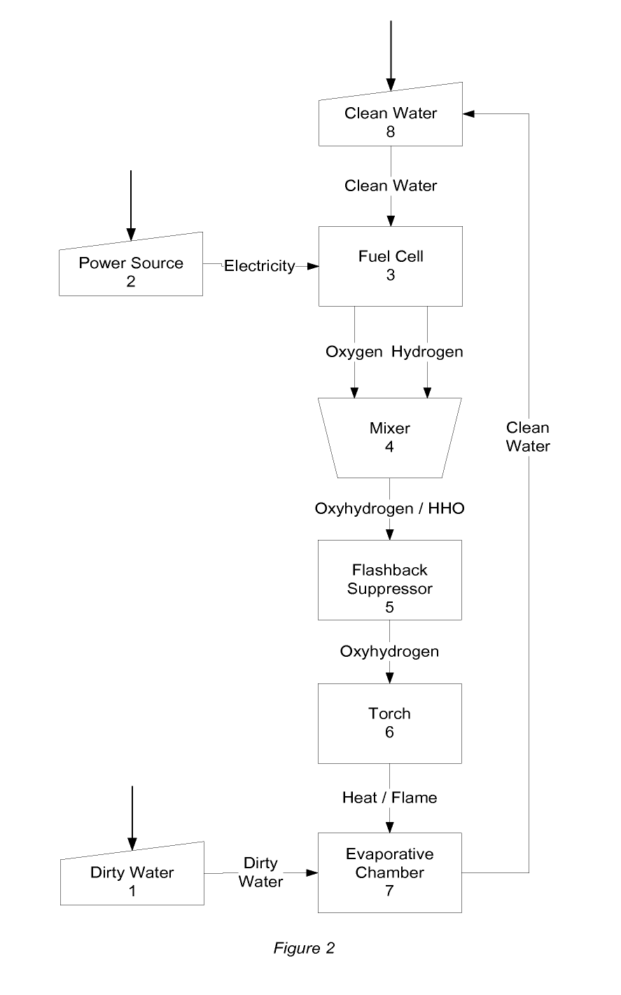

FIG. 2 shows the operational steps of my water purifier.

Dirty water is added to the dirty water tank 1. The dirty water flows to the evaporative chamber 7 waiting to be heated into steam.

In parallel the fuel cell 3 functioning in oxygen/hydrogen production mode consumes electricity from the power source 2, and clean water from the clean water tank 8. The power source is provided power from an external source such as solar generation, batteries, the electrical grid, wind turbines etc. The clean water tank 8 is initially primed from a clean water source however in functioning mode the system will provide part of the clean water output to replenish the clean water source for the fuel cell 3. The fuel cell 3 produces oxygen and hydrogen.

The oxygen and hydrogen are mixed in the mixer 4 to form a mix referred to as Oxyhydrogen, HHO, or Browns Gas.

The Oyxhydrogen is provided to the flashback suppressor 5 which ensures that ignitited Oxyhydrogen gas cannot flow back from the torches 6.

A plurality of torches 6 ignite the Oxyhydrogen to produce heat and clean water. The clean water is captured and transferred to the clean water tank 8.

The heat/flames are used to heat water in the evaporative chamber 7 to produce steam. This steam is cooled and collected to produce clean water which is returned to the clean water tank 8.

In summary of operation my invention starts in a state primed with clean water. External inputs include dirty water and electrical power. Operating it creates more clean water than the initial priming amount from dirty water, leaving impurity residue.

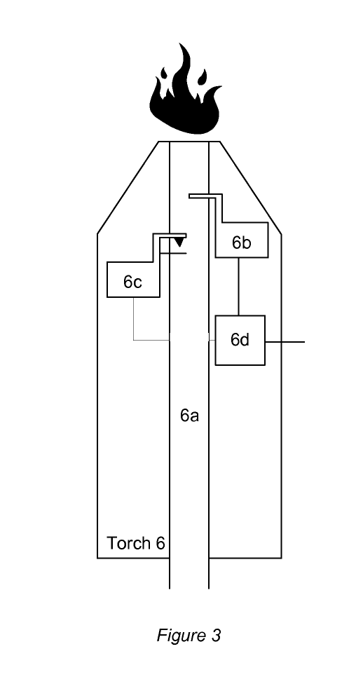

FIG. 3 shows key components of a torch.

The torch 6 consists of means to convert Oxyhydrogen to heat/flames.

A Oxyhydrogen tube 6a flows Oxyhydrogen through the torch.

A heat sensor 6b senses if the torch is ignited indicating that state to an output line.

A igniter 6c ignites the Oxyhydrogen in the Oxyhydrogen tube 6a.

A controller 6d reads the state line from the heat sensor 6b to determine if the torch is lit. Logic in the controller sends electricity to the igniter 6c if the torch is not lit. Optionally the controller 6d can control the flow of Oxyhydrogen through valves in 6a to achieve maximum efficiency.

Some example application are provided below. They are meant to be indicative of utilitarian applications, but not limiting in the scope of this application.

A stand alone “village size” variant is equipped to provide clean water to a village without external grid connections, such as in a third world country. Electrical power is provided by photovoltaic solar arrays, wind turbines, etc. This type of variant will generally, but not always, be implemented in a non-portable configuration.

A portable “military” or “recreational camper” variant is equipped without external grid connections, but is sized and packaged for mobile applications. Electrical power is provide by an external source such as a battery or generator. Consideration is taken in the design of this variant to minimize the effects of movement and slanted configuration.

A grid integrated “industrial” variant is equipped to provide clean water to a large population segment. This variant is integrated with large industrial power sources, large dirty water sources, and is scaled up for high capacity production of clean water. The basic design of my water purifier could be sized up as well as parallelized for this variant.

### Operation of Invention

FIG. 1 shows a basic version of my water purifier. The purifier system receives external inputs of dirty water into a dirty water tank 1, and power from a power source 2. Clean water is stored in a clean water tank 8 and flows to a fuel cell 3. The fuel cell 3 converts clean water 8 to oxygen and hydrogen using power from the power source 2. Oxygen and Hydrogen flow from the fuel cell 3 to a mixer 4 to create a highly flammable Oxyhydrogen mix. The Oxyhydrogen flows from the mixer 4 to a flashback suppressor 5. The flashback suppressor 5 ensures that a flame later in the system cannot burn too far back into the system. Oxyhydrogen flows from the flashback suppressor to a plurality of torches 6 where the Oxyhydrogen is ignited. As the Oxyhydrogen is burns it produces clean water and heat. The water is collected by a burn capture device 9. The heat is transferred to a steam still 7. The steam still 7 is fed with dirty water from the dirty water tank 1, and heat from the Oxyhydrogen torches 6. As water boils and converts to steam in the steam still 7 it rises to the top of the steam still 7, condenses, and flows down the sloped top to a clean water collection portion of the steam still 7a. The clean water flows from the steam still clean water collection section 7a to the clean water tank 8. The clean water tank provides access to the purified water system product as well as maintains a reserve of clean water for future production.

### DESCRIPTION OF ALTERNATIVE EMBODIMENTS

This invention can be implemented in the following means. This list is not intended to limit the scope of applications rather to show possible embodiments.

Small portable solution for use by hikers and backpackers.

Mid size portable solution for installation in recreational vehicles, busses, etc.

Small and mid size non-portable solution for use in remote areas such as third world villages or for off grid living.

Large non portable solution for industrial water purification such as large desalinization plants.

### CONCLUSION, RAMIFICATIONS, AND SCOPE

Accordingly the reader will see that, according to the invention, I have provided an improved means of water purification. Through the use of Oxyhydrogen as a partially reclaimable heat source for a steam sill this invention purifies water more efficiently with less maintenance than previous methods.

While the above description contains many specificities, these should not be construed as limitations on the scope of the invention, but as exemplifications of the presently preferred embodiments thereof. Many other ramification and variations are possible within the teachings of the invention. For example, addition of secondary filtration to ensure a clean water feed to the fuel cell.

Thus the scope of the invention should be determined by the appended claims and their legal equivalents, and not by the examples given.

What is claimed is:

1. A system for purifying water, comprising:
a source of oxyhydrogen;
a burn chamber for combusting the oxyhydrogen;
to an evaporative chamber heated by the combusting of the oxyhydrogen having a clean water collection section; and
a clean water tank in communication with the clean water collection section of the evaporative chamber.

2. The system of claim 1, wherein the burn chamber is has an opening in communication with the clean water tank.

3. The system of claim 1, wherein the source of oxyhydrogen is a fuel cell.

4. The system of claim 3, further including a power source providing electrical energy to the fuel cell.

5. The system of claim 1, further including a dirty water tank in communication with the evaporative chamber.

6. The system of claim 4, wherein the burn chamber includes a plurality of torches.

7. A method of generating clean water, comprising the steps of:
generating a source of oxyhydrogen;
combusting the oxyhydrogen to create heat;
heating a dirty water in an evaporative chamber; and
collecting a clean water from the evaporative chamber.

8. The method of claim 7, wherein the step of generating the source of oxyhydrogen includes the step of running a fuel cell in reverse.

9. The method of claim 8, wherein the step of running the fuel cell in reverse includes the step of providing an electrical power to the fuel cell.

10. The method of claim 7, wherein the step of combusting the oxyhydrogen includes the step of collecting, clean water from the combusting of the oxyhydrogen.

11. The method of claim 7, further including the step of providing a source of dirty water to the evaporative chamber.

12. The method of claim 7, wherein the step of generating the oxyhydrogen includes the step of creating a hydrogen.

13. The method of claim 12, further including the step of mixing the hydrogen with an oxygen.

14. The method of claim 7, wherein the step of combusting the oxyhydrogen includes the step of igniting the oxyhydrogen in a torch.

15. A system for purifying water comprising:
a reverse fuel cell producing a hydrogen;
a burn chamber receiving the hydrogen and combusting a oxyhydrogen to produce heat;
a evaporative chamber heated by the combusting of the oxyhydrogen; and
a clean water tank in communication with the evaporative chamber.

16. The system of claim 15, further including an outlet of the burn chamber in communication with the clean water tank.

17. The system of claim 15, further including an electrical power source providing power to the reverse fuel cell.

18. The system of claim 15, further including a mixer receiving the hydrogen and oxygen from the fuel cell.

19. The system of claim 15, including a dirty water tank providing dirty water to the evaporative chamber.
